(19) United States
(12) Patent Application Publication
(10) Pub. No.: US 2004/0181365 A1
(43) Pub. Date: Sep. 16, 2004

(54) Adjoint-based gradient driven method for identifying unkown parameters of non-linear system models

(76) Inventors: Sharon Liu, Ann Arbor, MI (US); Thomas R. Bewley, La Jolla, CA (US)

Correspondence Address: CHRISTOPHER DEVRIES, General Motors Corporation, Legal Staff, Mail Code 482-C23-B21, P. O. Box 300, Detroit, MI, 48265-3000, US

(21) Appl. No.: 10/696,081

(22) Filed: Oct. 29, 2003

Related U.S. Application Data
(60) Provisional application No. 60/455,083, filed on Mar. 13, 2003.

(51) Int. Cl. G06F 15/00

(52) U.S. Cl. 702/182; 73/856

(57) ABSTRACT

A method is provided for identifying the unknown parameters of a non-linear dynamic system model that has one or more system inputs. The governing state equation is derived from the non-linear dynamic system model. An adjoint equation is determined from the governing state equation, and a perturbation cost function is determined, based at least in part on the determined adjoint equation. Changes in the perturbation cost function that result from incremental changes in one or more of the system inputs and from arbitrarily chosen values of one or more of the unknown model parameters are iteratively determined to thereby identify the unknown model parameters.

### CROSS-REFERENCES TO RELATED APPLICATIONS

This application claims the benefit of U.S. Provisional Application No. 60/455,083, filed Mar. 13, 2003.

### FIELD OF THE INVENTION

The present invention generally relates to a method for dynamic system parameter identification and, more particularly, to an adjoint-based gradient driven method for identifying nonlinear system dynamic parameters for automotive powertrain systems and subsystems.

### BACKGROUND OF THE INVENTION

Controllers for systems and subsystems, such as engine powertrain systems and subsystems, are increasingly being implemented using modern control techniques. Modern control techniques are derived from mathematical models that mathematically describe the dynamic behavior of the system to be controlled. The mathematical model of such systems can be derived, for example, from one or more physical laws, or from experimental data using known regression techniques.

No matter how the mathematical system model is derived, it should be verified to ensure that it represents the real system with sufficient accuracy. To do so, the computed outputs of the system model may be compared to actual, experimentally sensed data that describe the same output. Mathematical methodologies, such as least square fit algorithms, may then be used to provide some measure of difference between the computed and actual outputs. If this indicates that the fit is not acceptable, appropriate modifications may be made to the model, to the initial conditions, and/or to other characteristics, to improve the fit. This process is iterative in nature, and is conducted until the difference between the computed and actual outputs sufficiently converge, which can be both time consuming and costly.

Accordingly, it is desirable to provide a method for identifying the unknown parameters of a non-linear dynamic system that is computationally efficient as compared to presently known methods, is relatively less time consuming than presently known methods and, thus, is less costly than presently known methods. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method is provided for identifying the unknown parameters of a non-linear dynamic system model that has one or more system inputs. The method includes determining a governing state equation from the system model. A generalized cost function that represents a performance objective for the system is determined. An adjoint equation is determined based at least in part on the governing state equation. A gradient is determined based at least in part on the adjoint equation. The governing state equation, the adjoint equation, and the generalized cost function are supplied to a processor. The processor is then caused to iteratively determine changes in the generalized cost function that result from incremental changes in arbitrarily chosen values of one or more of the unknown model parameters to thereby identify the unknown model parameters.

A computer-readable medium containing computer executable code that instructs a computer to perform the above-described method is also provided.

### BRIEF DESCRIPTION OF THE DRAWINGS

The present invention will hereinafter be described in conjunction with the following drawing figures, wherein like numerals denote like elements, and:

FIG. 1 is a flowchart depicting a computational method for identifying unknown model parameters of a non-linear dynamic system model, such as a model of the torque converter of FIG. 2, according to an embodiment of the present invention;

FIG. 2 is a simplified functional block diagram of an automobile powertrain system;

FIG. 3 is a simplified cross-section of a torque converter that may be included in the powertrain system of FIG. 2;

FIG. 4 is a simplified representation of a control volume based on the torque converter depicted in FIG. 3; and

FIG. 5 is a graph depicting the response of a non-linear system model of the torque converter of FIGS. 3 and 4, in which the model parameters were determined using the process illustrated in FIG. 1.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the drawings.

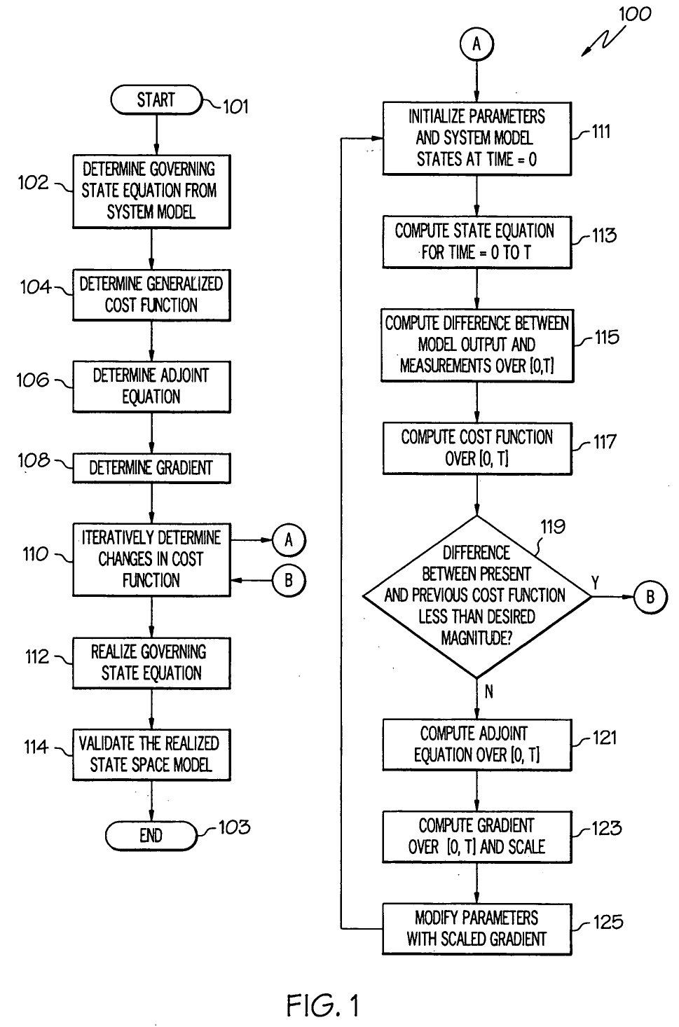

A flowchart depicting a generalized process 100 for determining the system parameters of a non-linear dynamic system model according to an exemplary embodiment is shown in FIG. 1. It should be appreciated that the process 100 is preferably implemented, in whole or in part, on an appropriately programmed general purpose computer. Alternatively, a specialized device may be designed and constructed to implement the method in hardware, firmware, software, or combination thereof. In the following description, the parenthetical references in FIG. 1 correspond to the particular reference numerals of the methodological flow illustrated therein.

As FIG. 1 indicates, the first step to identify system model parameters is to determine a governing state equation from the system model. An general form for the governing state equation for the nonlinear systems we may consider with this approach is:

q=N(q,θ,ψ) on 0<t<T, for q=q₀, at t=0, (1)

where θ is the parameter vector being sought, and N is a continuous, differentiable nonlinear function of the state vector q, the parameter vector θ, and the exogenous input vector ψ.

After the state equation is determined, an adjoint optimization procedure is defining is then implemented to identify the model parameters (104-110). Adjoint analysis is a mathematical tool that is used to determine the gradient information that is central to efficient high-dimensional optimization strategies. Although adjoint analysis has been used previously to conduct control input optimization, it has not been used to conduct model parameter identification, which is the subject of the present invention. As FIG. 1 indicates, the first step in the adjoint optimization procedure is defining a cost function that represents the performance objective for the process (104). A generalized expression of the cost function (J) is shown below.

$$\begin{matrix}J = \frac{1}{2} {\int }_{0}^{T} ( Cq - y ) * Q ( Cq - y ) ⅆ t + \frac{1}{2} ( {C}_{o} {q}_{o} - {y}_{o} ) * \\ {R}_{o} ( {C}_{o} {q}_{o} - {y}_{o} ) + \frac{1}{2} ( θ - \overline{θ} ) * \overline{R} ( θ - \overline{θ} )\end{matrix} \qquad ( 2 )$$

In the context of the present embodiment, the objective is output validation of the model to ensure the parameters were correctly determined. The error between the model output Cq and the measured data y is penalized by adjusting the weighting matrix Q. Moreover, since the measured data includes noise, the single sample for the initial condition q₀ cannot be provided with 100% certainty. Hence, the model initial conditions are permitted to vary by adjusting the weighting matrix Rₒ. The parameter values can be constrained near reference values \overline{θ} by adjusting the cost weighting matrix \overline{R}.

The model output validation objective is met when equation (2) is minimized with respect to the parameters θ being sought, subject to the governing state equation (1). Knowing the effect of parameter changes on equation (2) helps search for this minimum. Now, letting q′ be the small change in the state q when the parameters are perturbed a small amount, and defining the following equation:

L q′Δ(∂/∂t−A)q′, (3)

which is the linearization about a trajectory q (θ,qₒ), a perturbation equation can be written as follows:

Lq′=B_{θ}θ′ on 0<t<T, for q′=0, at t=0, (4)

where θ′ is a parameter perturbation from θ, that drives the state perturbation, q′, which has an associated non-negligible perturbation cost function defined as:

J=∫₀^{T}(Cq−y)*QCq′dt+(Cₒq₀−yₒ)*RₒCₒq′ₒ+(θ−\overline{θ})*\overline{R}θ′. (5)

The sensitivity of equation (5), the perturbation cost function, with respect to the parameter perturbations θ′ may then be found, since this determines how to minimize the cost function. To do so, the adjoint analysis proceeds by introducing an inner product defined as follows:

<r, q′>=∫₀^{T}r*q′dt, (6)

where the asterisk implies the transpose operation. This inner product yields the adjoint identity:

<r, L q′>=<L*r, q′>+b, (7)

where r is introduced as the adjoint state, such that L*r=(−∂/∂−A*)r, and such that b=[r*q′]_{t=T}−[r*q′]ₜ₌₀. From the adjoint identity, and choosing the adjoint state equation to be driven by the model validation error defined in the cost function, the following adjoint equation is obtained:

L*r=C*Q(Cq−y) on 0<t<T, for r=0, at t=T. (8)

Once the adjoint equation is determined (106), a perturbation cost function is then easily computable. Specifically, by combining equations (4) (the perturbed state equation), (7) (the adjoint identity) and equation (8) (the adjoint equation), the following alternative expression for the perturbation cost function (5) may be obtained:

J=[∫₀^{T}B_{θ}*rdt+\overline{R}(θ−\overline{θ})]*θ′+[CₒRₒ (Cₒqₒ−yₒ)+r(0)]*q′ₒ (9)

The unknown model parameters are then identified using equation (9) by iteratively determining changes to the cost function (equation (2)) with respect to changes in the system initial conditions and the model parameters. Specifically, arbitrary values for both the initial conditions q′₀ and the unknown model parameters θ′ are selected, and the cost sensitivities associated with these changes are determined. In particular, the following gradients are determined (108), and then iterative calculations are conducted (110) using these gradients to determine the sensitivities and the minimization

$$\begin{matrix}\frac{DJ}{D θ} = {B}_{θ}^{*} r + \overline{R} ( θ - \overline{θ} ) , and & ( 10 ) \\ \frac{DJ}{{Dq}_{o}} = {C}_{o}^{*} {R}_{o} ( {C}_{o} {q}_{o} - {y}_{o} ) + r ( 0 ) . & ( 11 )\end{matrix}$$

A particular preferred embodiment of the iterative calculations that are carried out as part of the generalized functional step 110 are also illustrated in FIG. 1, as steps 111-125. The skilled artisan will readily appreciate and understand the steps illustrated in this portion of the flowchart, and will therefore not be described herein in further detail.

The determined model parameters are then used to realize the original system model state equation using the same state space notation that is used in the adjoint analysis process (112). Thereafter, the realized system model state equation may be validated against one or more sets of experimental data (114).

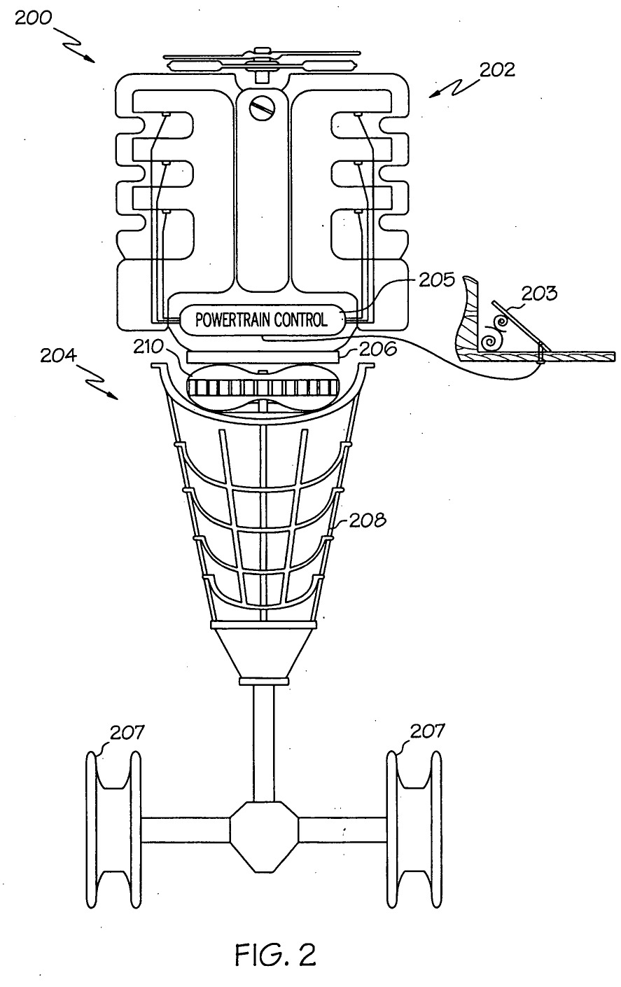

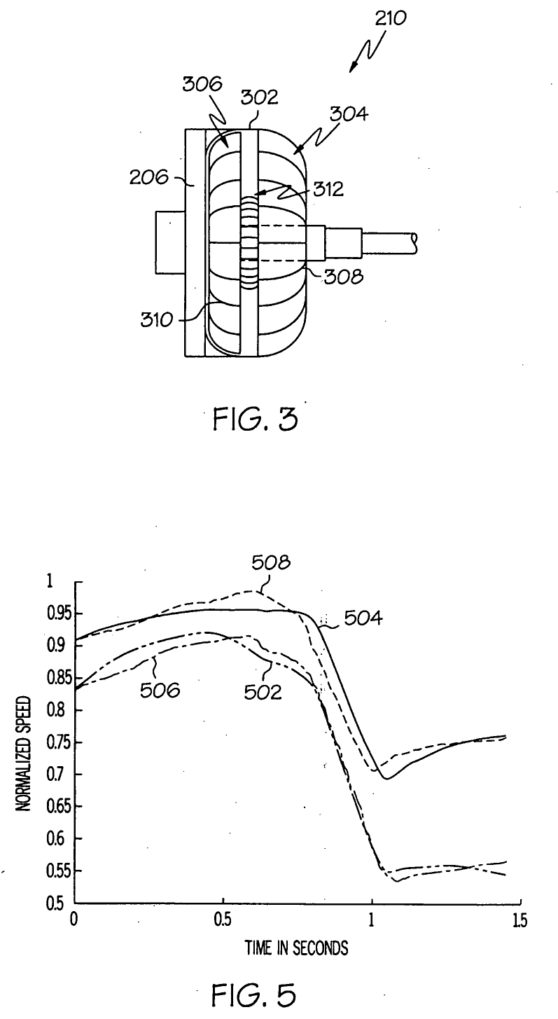

An example of how the above process can be applied to an automobile powertrain system will now be discussed. Before doing so, an exemplary powertrain system will first be described. Turning first to FIG. 2, a schematic diagram of an automobile powertrain system 200 is depicted. The powertrain system 200 includes an engine 202 and a transmission 204. The engine 202 is the prime mover of the vehicle into which the powertrain system 200 is installed. The engine 202 responsive to driver input from a throttle pedal 203 to a powertrain controller 205, and generates the torque necessary to accelerate the vehicle to a desired velocity, and to maintain the vehicle at this desired velocity. The torque generated by the engine 202 is supplied, via an engine flywheel 206, to the transmission 204. The transmission 204 in turn couples the torque supplied from the engine 202 to various numbers of driven wheels 207 via selected ones of a plurality of fixed gear ratios, which are housed within a transmission gearbox 208. The transmission 204 additionally includes a torque converter 210, which provides a hydrodynamic coupling between the engine 202 and the transmission 204. A simplified cross-section of an exemplary embodiment of the torque converter 210 is illustrated in FIG. 3, and will now be described.

The torque converter 210, which is exemplary of a general torque converter that may be used in any one of numerous powertrain systems 200, includes a housing 302, a pump 304, and a turbine 306. The housing 302 is coupled to the engine flywheel 206. Thus, as the engine 202 rotates the engine flywheel 206, the housing 302 is also rotated at the same rotational speed. The pump 304 is a centrifugal-type pump having an impeller with a plurality of fins 308. The fins 308 are coupled to the housing 302, and therefore rotate at the same rotational speed as the engine 202. As the pump 304 is rotated, hydraulic fluid within the housing 302, which is preferably automatic transmission fluid, is thrown outwardly by the impeller fins 308 toward the housing 302. This creates a vacuum in the center of the impeller that draws more fluid into the pump 304.

The turbine 306 includes a plurality of blades 310. The fluid that exits the pump 304 strikes the blades 310, causing the turbine 302, and thus the transmission 104, to rotate. The blades 310 are preferably curved, so that the fluid that enters the turbine 306 changes direction before it exits the center of the turbine 306. This directional change is what causes the turbine 306 to spin. As the fluid exits the center of the turbine 306, it is moving in a different direction than when it entered, which is a direction that is opposite that which the pump 304 is turning. Thus, the torque converter 210 may additionally include a stator 312. The stator 312 is centrally disposed between the pump 304 and the turbine 306, and redirects the fluid returning from the turbine 306 before it reaches the pump 302.

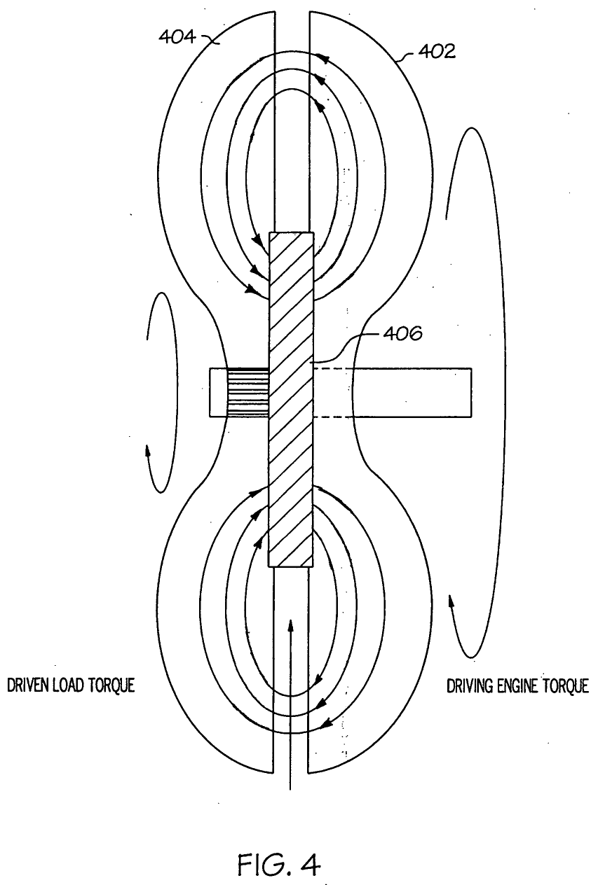

To apply the process 100 described above to the powertrain system 200, and more particularly to the torque converter 210 subsystem, a model of the torque converter is first developed. To do so, the torque converter 210 is modeled, as shown in FIG. 4, as a combination of two fixed control volumes 402 and 404, with the stator volume excluded. The first control volume 402 contains the automatic transmission fluid in the pump 304, and the second control volume 404 contains the automatic transmission fluid in the turbine 306. The first 402 and second 404 control volumes share a boundary 406 at the interface where the fluid leaves the pump 304 and enters the turbine 306, and vice-versa. The conservation of momentum equation for a fixed control volume, delineated below, is then applied twice to obtain two equations, one for each control volume:

$$\begin{matrix}r \times {F}_{s} + {\int }_{CV} r \times g ρ ⅆ V + {T}_{shaft} = \frac{\partial }{\partial t} {\int }_{CV} r \times \vec{V} ρ ⅆ V + \\ {\int }_{CS} r \times \vec{V} ρ \vec{V} \cdot ⅆ A ,\end{matrix} \qquad ( 12 )$$

where V is the fluid velocity, p is the fluid density, CS is the control surface around each control volume 402, 404, r is the appropriate moment arm; Fₛ is any force affecting the control surface; ∫_{CV}r×gpdV is any force caused by gravity (g) that affects the control volume; and T_{shaft} is the externally applied mechanical torque.

Due to the symmetry of the torque converter 210, the net gravitational force (g) for both the pump 304 and the turbine 302 is zero. There are, however, three forces that affect the control surfaces. The first is skin friction loss along the path of the pump impeller fins 308 and the turbine blades 310. As is generally known, skin friction loss is a linear function of the fluid speed. The second force is the shear loss that is incurred at the boundary 406 between the first 402 and second 404 control volumes. The shear loss is a linear function of slip (ΔN=N_{engine}−N_{turbine}). And, the third force that acts on the control surfaces is the head loss that is also incurred at the boundary 406 between the first 402 and second 404 control volumes. The head loss is a generally known quadratic function of slip. As regards the externally applied mechanical torque, for the pump 304 this is any brake torque that is applied, and for the turbine 306 this the vehicle load torque transferred by the gear shifting device in the gear box 208.

Now, by combining equation (12) for both of the control volumes 402 and 404, and consolidating various terms in a generally well-known fashion, the following coupled expression for the torque converter system is obtained:

θₐγ_{turbine}+θ_{b}N_{turbine}+θ_{c}N_{turbine}N_{engine}+θ_{d}N_{engine}=θₑN_{engine}+θ_{f}N_{turbine}+θ_{g}N²_{engine}+θhN²_{turbine}

θᵢγ_{engine}+θⱼN_{turbine}+θₖN_{turbine}N_{engine}+θₗN_{engine}=θₘN_{engine}+θₙN_{turbine}+θₒN²_{engine}+θₚN²_{turbine} (13)

For the purposes of system identification, the system output is chosen to be the full state, consisting of both engine speed (N_{engine}) and turbine speed (N_{turbine}), and for simplicity, consider the engine torque (γ_{engine}), the turbine torque (γ_{turbine}), and the transmission shaft speed (Nₒᵤₜₚᵤₜ), to be exogenous inputs, that is given signals or measurements for all time. However, the lack of available turbine torque measurements required some analysis, which show that the turbine torque can instead be approximated by:

$${γ}_{turbine} \approx {θ}_{q} {N}_{output} + {θ}_{r} {γ}_{output} + {θ}_{s} \frac{{N}_{engine}}{{N}_{turbine}} {γ}_{engine} , \qquad ( 14 )$$

where transmission shaft torque (γₒᵤₜₚᵤₜ) and transmission shaft speed (Nₒᵤₜₚᵤₜ), are accessible measurements. Thus, rather than turbine torque, the transmission shaft torque is considered an exogenous input along with the engine torque and transmission shaft speed (Nₒᵤₜₚᵤₜ),.

Now, rearranging equation (13) so that the time derivatives are on the left, appropriately substituting in equation (14), and consolidating constant parameters, the governing state equation for the torque converter 210 is obtained:

$$\begin{matrix}[ \begin{matrix}{\dot{N}}_{turbine} \\ {\dot{N}}_{engine}\end{matrix} ] = \{ [ \begin{matrix}{θ}_{1} & {θ}_{2} \\ {θ}_{10} & {θ}_{11}\end{matrix} ] + \\ [ \begin{matrix}{θ}_{3} {N}_{turbine} + {θ}_{4} {N}_{engine} & {θ}_{5} {N}_{engine} \\ {θ}_{12} {N}_{turbine} + {θ}_{13} {N}_{engine} & {θ}_{14} {N}_{engine}\end{matrix} ] \} \\ [ \begin{matrix}{N}_{turbine} \\ {N}_{engine}\end{matrix} ] + [ \begin{matrix}{θ}_{6} & {θ}_{7} & {θ}_{8} \frac{{N}_{engine}}{{N}_{turbine}} + {θ}_{9} \\ {θ}_{15} & {θ}_{16} & {θ}_{17} \frac{{N}_{engine}}{{N}_{turbine}} + {θ}_{18}\end{matrix} ] \\ [ \begin{matrix}{N}_{output} \\ {γ}_{output} \\ {γ}_{engine}\end{matrix} ]\end{matrix} \qquad ( 15 )$$

Turning now to the remainder of the process 100, the torque converter governing state equation (equation (15)) is applied with the adjoint equation (equation (8)), and the cost function (equation (9)). Then, iteratively calculating the gradients (equations (10) and (11)), the realization of equation (15), using the system model notation delineated in state equation (1) above is:

$$\dot{q} = [ \begin{matrix}{\overline{N}}_{turbine} \\ {\overline{N}}_{engine}\end{matrix} ] , ψ = [ \begin{matrix}{\overline{γ}}_{engine} \\ {\overline{γ}}_{output} \\ {N}_{output}\end{matrix} ] \qquad ( 16 )$$

It is noted that the over bars indicated in equations (16) above indicate that the variables are normalized. Specifically, the speed variables are normalized to the maximum engine speed, and the torque variables are normalized to maximum transmission shaft torque.

The state space model (equation (15)) with the identified system parameters (θ₁₋₁₈) was validated against experimental data associated with a 1-2 upshift during a 30% constant throttle pedal maneuver. For this single set of data, no reference parameters are known, and therefore the parameter weight (\overline{R}) is zero. In addition, the weight on the output error (Q) is chosen as the identity matrix, and a non-zero value of the initial condition weight (Rₒ) is chosen. The results are shown in FIG. 5, which depicts normalized turbine speed and normalized engine speed versus time for both the simulation model output 502 and 504, respectively, and the experimental data 506 and 508, respectively. Values of measured engine torque, transmission shaft torque, and transmission shaft speed were used as system inputs.

It will be appreciated that the identified model should be validated against more than one data set, since experimental measurements may vary for a specific operational maneuver, such as the 1-2 upshift during a 30% throttle pedal maneuver described above, from experiment to experiment. Thus, to provide increased assurance of model validity, the parameter identification process 100 should be validated against an ensemble of data sets. For example, in a particular embodiment, the torque converter system model parameters (θ₁₋₁₈) were validated against an ensemble of 10 data sets. In conducting such an extended validation, the parameters and initial conditions found with the single data set were used as the initial guesses. The cost function now includes the integral of the error from all 10 data sets over the time interval [0, T], as well as the variation in initial conditions with respect to the 10 different measured initial conditions.

When a plurality of data sets is used, the overall process 100 is unchanged from that used for a single data set; however, the process 100 now has information available from all of the data sets in the ensemble. Therefore, the model is more generally validated. Indeed, it was found that the torque converter model that was validated based on the ensemble of data sets provided a response that closely approximated a 1-2 upshift for an arbitrary constant pedal maneuver.

The above-described methodology provides for the identification of the unknown parameters of a non-linear dynamic system in a manner that is computationally efficient as compared to presently known methods. The method is relatively less time consuming than presently known methods and, thus, is less costly than presently known methods. Moreover, the method provides the flexibility to allow the initial conditions used during the parameter identification process to be varied from preferred values, the method allows the state values to stay closer to nominal values, which ensures physically meaningful results are provided, and allows more flexibility.

While an exemplary embodiment(s) has been presented in the foregoing detailed description of the invention, it should be appreciated that a vast number of variations exist. It should also be appreciated that these exemplary embodiments are only examples, and are not intended to limit the scope, applicability, or configuration of the invention in any way. Rather, the foregoing detailed description will provide those skilled in the art with a convenient road map for implementing a preferred embodiment of the invention. It being understood that various changes may be made in the function and arrangement of elements described in an exemplary preferred embodiment without departing from the spirit and scope of the invention as set forth in the appended claims.

What is claimed is:

1. A method of identifying unknown model parameters of a non-linear dynamic system model having one or more system inputs, comprising:
determining a governing state equation from the system model;
determining a generalized cost function that represents a performance objective for the system;
determining an adjoint equation based at least in part on the governing state equation;
determining a gradient based at least in part on the adjoint equation; and
supplying the governing state equation, the adjoint equation, and the generalized cost function to a processor; and
causing the processor to iteratively determine changes in the generalized cost function that result from incremental changes in arbitrarily chosen values of one or more of the unknown model parameters to thereby identify the unknown model parameters.

2. The method of claim 1, further comprising:
determining a perturbation state equation based at least in part on the governing state equation; and
determining a perturbation cost function based at least in part on the perturbation state equation and the generalized cost function,
wherein the adjoint equation is determined based at least in part on the perturbation cost function.

3. The method of claim 1, further comprising:
determining one or more initial states for solving the governing state equation;
supplying one or more of the initial states to the processor; and
causing the processor to iteratively determine changes in the cost function that result from incremental changes in one or more of the initial states.

4. The method of claim 1, wherein:
the adjoint equation includes one or more adjoint states; and
the incremental changes are driven by gradients derived from the adjoint states.

5. The method of claim 1, wherein the processor iteratively determines the changes in the cost function until a specified accuracy criterion is met.

6. The method of claim 1, wherein the processor iteratively determines the changes in the cost function until a predetermined number of iterations is completed.

7. The method of claim 1, further comprising:
determining the state equation, cost function, adjoint equation, and gradient by supplying one or more exogenous inputs.

8. The method of claim 1, further comprising:
determining an adjoint identity, wherein the adjoint equation is additionally determined from the governing state equation.

9. The method of claim 1, further comprising:
validating the non-linear dynamic model using the identified model parameters against one or more sets of experimentally determined data.

10. The method of claim 1, further comprising:
validating the non-linear dynamic model using the identified model parameters against one or more sets of simulated data.

11. The method of claim 1, wherein the non-linear dynamic system model includes one or more powertrain system models.

12. A computer-readable medium containing computer executable code that instructs a computer to perform method steps for identifying unknown model parameters of a non-linear dynamic system model having one or more system inputs, the method comprising:
determining a governing state equation from the system model;
determining an adjoint equation based at least in part on the governing state equation;
determining a generalized cost function based on one or more performance objectives for the system;
determining a gradient based at least in part on the determined adjoint equation;
supplying the governing state equation, the adjoint equation, and the generalized cost function to a processor; and
causing the processor to iteratively determine changes in the generalized cost function that result from incremental changes in arbitrarily chosen values of one or more of the unknown model parameters to thereby identify the unknown model parameters.

13. The computer-readable medium of claim 12, wherein the method further comprises:
determining one or more initial states for solving the governing state equation;
supplying one or more of the initial states to the processor; and
causing the processor to iteratively determine changes in the cost function that result from incremental changes in one or more of the initial states.

14. The computer-readable medium of claim 12, wherein the method further comprises:
the adjoint equation includes one or more adjoint states; and
the incremental changes are driven by gradients derived from the adjoint states.

15. The computer-readable medium of claim 12, wherein the processor iteratively determines the changes in the cost function until a specified accuracy criterion is met.

16. The computer-readable medium of claim 12, wherein the processor iteratively determines the changes in the cost function until a predetermined number of iterations is completed.

17. The computer-readable medium of claim 12, wherein the method further comprises:
determining the state equation, cost function, adjoint equation, and gradient by supplying one or more exogenous inputs.

18. The computer-readable medium of claim 12, wherein the method further comprises:
determining an adjoint identity, wherein the adjoint equation is additionally determined from the governing state equation.

19. The computer-readable medium of claim 12, wherein the method further comprises:
validating the non-linear dynamic model using the identified model parameters against one or more sets of experimentally determined data.

20. The computer-readable medium of claim 12, wherein the method further comprises:
validating the non-linear dynamic model using the identified model parameters against one or more sets of simulated data.

21. The computer-readable medium of claim 12, wherein the non-linear dynamic system model includes one or more powertrain system models.

22. A method of identifying unknown model parameters of a non-linear dynamic system model of an automobile powertrain system having one or more system inputs, the method comprising:
determining a governing state equation for the powertrain system from the powertrain system model;
determining a cost function based at least in part on one or more powertrain system performance objectives;
determining a perturbation state equation from the governing state equation for the powertrain system;
determining an adjoint equation from the governing state equation for the powertrain system;
determining a perturbation cost function based at least in part on the determined adjoint equation;
determining a gradient based at least in part on the determined adjoint equation;
supplying the governing state equation, the adjoint equation, and the perturbation cost function to a processor; and
causing the processor to iteratively determine changes in the perturbation cost function that result from incremental changes in arbitrarily chosen values of one or more of the unknown powertrain system model parameters to thereby identify the unknown powertrain system model parameters.

23. The method of claim 22, further comprising:
determining one or more initial states for solving the governing state equation;
supplying one or more of the initial states to the processor; and
causing the processor to iteratively determine changes in the cost function that result from incremental changes in one or more of the initial states.

24. The method of claim 22, wherein:
the adjoint equation includes one or more adjoint states; and
the incremental changes are driven by gradients derived from the adjoint states.

25. The method of claim 22, wherein the changes in the cost function are iteratively determined until a specified accuracy criterion is met.

26. The method of claim 22, wherein the changes in the cost function are iteratively determined until a predetermined number of iterations is completed.

27. The method of claim 22, further comprising:
determining the state equation, cost function, adjoint equation, and gradient by supplying one or more exogenous inputs from powertrain system measurements or controller generated signals.

28. The method of claim 22, further comprising:
determining an adjoint identity, wherein the adjoint equation is additionally determined from the governing state equation.

29. The method of claim 22, further comprising:
validating the non-linear dynamic model using the identified model parameters against one or more sets of experimentally determined or simulated data.
